(19) United States
(12) Patent Application Publication
(10) Pub. No.: US 2012/0044800 A1
(43) Pub. Date: Feb. 23, 2012

(54) PROTECTION OF USER DATA TRANSMISSION THROUGH A TRANSPORT NETWORK

(75) Inventor: Claudio Coltro, Milano (IT)

(73) Assignee: ALCATEL LUCENT, Paris (FR)

(21) Appl. No.: 13/266,030

(22) PCT Filed: May 4, 2010
(86) PCT No.: PCT/EP2010/055996

§ 371 Date: Oct. 24, 2011

(30) Foreign Application Priority Data
May 6, 2009 (EP) 09305403.9

(51) Int. Cl. H04L 12/26

(52) U.S. Cl. 370/217

(57) ABSTRACT

It is disclosed a method for protecting transmission of user data transmitted from a first to a second user network through a transport network. The user data have a maximum transmission rate. The method comprises: in the transport network, in a failure-free status, providing a first and a second path having an overall capacity equal to the maximum transmission rate; transmitting a first portion of user data along the first path, and a second portion of user data along the second path; at a network management server cooperating with the transport network, detecting a failure affecting transmission of the second portion; at the network management server, switching from the failure-free status to a failure status by operating the transport network so as to increase capacity of the first path to the maximum transmission rate; and at the first user network, transmitting the user data along the first path only.

### FIELD OF THE INVENTION

The present invention relates to the field of the communication networks, in particular to protection of user data transmission through a transport network.

### BACKGROUND

It is known that a communication network comprises a number of network elements interconnected for transporting data associated to various communication services. A communication network may be either a circuit-switched network or a packet-switched network.

In circuit-switched networks, data are typically transported along predefined paths, in the form of continuous data flows arranged in data containers. Exemplary circuit-switched networks are SDH (Synchronous Digital Hierarchy) networks, SONET (Synchronous Optical NETwork) and OTN (Optical Transport Network). In SDH/SONET networks and OTN networks, different types of data containers are provided, that are arranged according to a hierarchical structure. For instance, in SDH/SONET networks, lower order virtual containers and higher order virtual containers are different types of data containers. On the other hand, in OTN networks, optical channel payload units (OPU) and optical data units (ODU) are different types of data containers.

In a circuit-switched network, the paths are typically manually established by an operator, by suitably configuring the network elements. Modifying the paths requires manually changing configuration of the network elements. However, recently, circuit-switched networks have been developed (that are called ASTN, i.e. Automatic Switched Transport Networks), having the capability of autonomously establishing and modifying the paths. In case a change occurs in the network (e.g. network elements are added to or removed from the network, or a failure occurs in the network), such circuit-switched networks are capable of automatically modifying the paths taking into account such change, without requiring any manual intervention by the operator.

In packet-switched networks, data to be transmitted are typically divided in packets, and each packet is independently routed by the network elements from source to destination. Exemplary packet-switched networks are Ethernet networks, IP (Internet Protocol) networks and ATM (Asynchronous Transfer Mode) networks.

A communication system may comprise a transport network implemented as a circuit-switched network and user networks connected to the transport network, each user network being implemented as a packet-switched network. In this exemplary communication system, the transport network is connected to each user network by means of a respective user-network interface (briefly termed “UNI”).

For allowing transmission of user data in the form of packets across the transport network, at each UNI the user data received from the associated user network may be suitably encapsulated, and then mapped into a number of data containers supported by the transport network, which data containers are then transmitted to the transport network. Similarly, each UNI receiving data containers from the transport network extracts the user data mapped therein, and then transmits the user data to the associated user network. For instance, in case the user network is an Ethernet network and the transport network is an SDH/SONET network, the Ethernet packets exchanged by such Ethernet network with other Ethernet networks may be encapsulated by means of the GFP (Generic Framing Procedure) technique, and then mapped in a number of higher order or lower order virtual containers. For instance, in case the user network is an Ethernet network and the transport network is an OTN network, the Ethernet packets exchanged by such Ethernet network with other Ethernet networks may be mapped in a number of OPUs or ODUs.

The operator of the transport network typically allocates, for a given user, a number of data containers reserved for transporting user data exchanged by such a user. Data containers may be allocated according to different criteria. For instance, in SDH/SONET networks and in OTN networks, two techniques are known: contiguous concatenation and virtual concatenation (briefly, “VCAT”). By referring to the SDH/SONET networks, according to the contiguous concatenation technique, all the higher order virtual containers and lower order virtual containers of a same administrative unit are allocated to a same user. According to the VCAT technique, each user has allocated a number of higher order virtual containers or lower order virtual containers that form a single virtual concatenation group, but that do not necessarily belong to a same administrative unti. According to the VCAT technique, the number of higher order virtual containers and lower order virtual containers of a virtual concatenation group may be dynamically changed by means of the known Link Capacity Adjustment Scheme (briefly, “LCAS”) according to the user traffic characteristics and to the transport network conditions.

### SUMMARY

In a communication system having a transport network, a first user network and a second user network connected by means of the transport network, user data exchanged between the first user network and the second user network are typically protected against failures occurring in the transport network as follows.

The first user network has a pair of edge network elements connected to the transport network by means of respective UNIs. Similarly, the second user network has a pair of edge network elements connected to the transport network by means of respective UNIs. A pair of paths crossing the transport network connects the pair of edge network elements of the first user network with the pair of edge network elements of the second user network.

Typically, each path of the pair has a capacity equal to the maximum transmission rate of the exchanging user data. For instance, in the above mentioned case of Ethernet packets transport over an SDH/SONET network, if the maximum transmission rate of the Ethernet packets is 8.96 Gbit/s, two paths are allocated in the SDH/SONET network, each having a capacity of 8.96 Gbit/s. This may be achieved for instance by allocating 64 higher order virtual containers VC-4 on the first path and 64 higher order virtual containers VC-4 on the second path, the transmission rate of a single higher order virtual container VC-4 being 140 Mbit/s. During normal operation, only 64 higher order virtual containers VC-4 are used. For instance, the first path may be fully used while the second path may be unused. Alternatively, an ECMP (“Equal-cost multi-path routing”) may be used, allowing to share transmission of the Ethernet traffic between the two paths. For instance, the Ethernet packets may be transported by 32 higher order virtual containers VC-4 of the first path (while the remaining 32 higher order virtual containers VC-4 are unused) and 32 higher order virtual containers VC-4 of the second path (while the remaining 32 higher order virtual containers VC-4 are unused).

When a failure occurs in the transport network, making at least part of the used resources unavailable, the user data are rerouted to the unused resources. For instance, in the above mentioned case wherein the Ethernet packets are transported by 32 higher order virtual containers VC-4 of the first path and 32 higher order virtual containers VC-4 of the second path, if a failure occurs on the first path, the Ethernet packets are rerouted to the second path that, as mentioned above, has allocated 64 higher order virtual containers VC-4, and may therefore support transmission of all the Ethernet packets.

The Applicant has perceived that the above solution for protecting transmission of user data in a transport network has some drawbacks. Indeed, such a solution disadvantageously implies an inefficient usage of the resources in the transport network, since it requires allocating an overall amount of resources doubling the maximum transmission rate of the user data and, in absence of failures, using only half of such allocated resources for transporting the user data. In other words, in absence of failure, 50% of the allocated resources is disadvantageously unused.

Accordingly, an object of the present invention is providing a method for protecting transmission of user data through a transport network that overcomes the aforesaid drawbacks, i.e. that allows using resources of the transport network in a more efficient way.

According to a first aspect, the present invention provides a method for protecting transmission of user data transmitted from a first user network to a second user network through a transport network, the user data having a maximum transmission rate, the method comprising:
a) in the transport network, in a failure-free status, providing a first path and a second path connecting the first user network with the second user network, the first path and the second path having an overall capacity equal to the maximum transmission rate;
b) transmitting a first portion of the user data along the first path, and transmitting a second portion of the user data along the second path;
c) at a network management server cooperating with the transport network, detecting a failure affecting transmission of the second portion;
d) at the network management server, switching from the failure-free status to a failure status by operating the transport network so as to increase capacity of the first path to the maximum transmission rate; and
e) at the first user network, transmitting the user data along the first path only.

Preferably, step a) comprises allocating a first number of data containers on the first path and a second number of data containers on the second path by means of a virtual concatenation technique implemented by the transport network.

Preferably, step d) comprises increasing the first number of data containers by operating a link capacity adjustment scheme implemented by the transport network.

Profitably, step c) comprises receiving at the network management server a management message from the transport network, the management message being indicative of the failure.

Preferably, after step c), the method further comprises, if the transport network is an automatic switched transport network, using automatic switching functionalities of the transport network for allocating a path portion bypassing the failure, if the failure occurs on the second path.

Preferably, step b) comprises implementing an equal-cost multi-path routing function in the first user network, so that the first portion is transmitted through a first edge network element of the first user network to the first path, and the second portion through a second edge network element of the first user network to the second path.

Preferably, the first user network automatically performs step e) in response to step d) by means of the equal-cost multi-path routing function.

According to a second aspect, the present invention provides a transport system comprising a transport network and a network management server cooperating with the transport network, the transport network being configured to connect a first user network and a second user network,

wherein the transport network has a first path and a second path configured to connect the first user network with the second user network,

wherein, in a failure-free status, the first path is suitable for supporting transmission of a first portion of user data and the second path is suitable for supporting transmission of a second portion of the user data, the first path and the second path having an overall capacity equal to a maximum transmission rate of the user data, and

wherein the network management server is configured to detect a failure affecting transmission of the second portion and, in response to the detection, to switch from the failure-free status to a failure status by operating the transport network so as to increase capacity of the first path to the maximum transmission rate, thereby allowing the first path supporting transmission of all the user data.

Preferably, the transport network is configured to implement a virtual concatenation technique and to use the virtual concatenation technique for allocating a first number of data containers on the first path and a second number of data containers on the second path.

Preferably, the transport network is configured to implement a link capacity adjustment scheme and the network management server is configured to operate the link capacity adjustment scheme for increasing capacity of the first path by increasing the first number of data containers.

Preferably, the network management server is configured to detect the failure by receiving from the transport network a management message indicative of the failure.

Preferably, the transport network is an automatic switched transport network configured to use automatic switching functionalities for allocating a path portion bypassing the failure, if the failure occurs on the second path.

According to a third aspect, the present invention provides a communication system comprising a first user network, a second user network and a transport system, the transport system comprising a transport network and a network management server cooperating with the transport network, the transport network connecting the first user network with second user network, wherein the transport system is as set forth above.

Preferably, the first user network is configured to implement an equal-cost multi-path routing function, so that the first portion is transmitted through a first edge network element of the first user network to the first path, and the second portion is transmitted through a second edge network element of the first user network to the second path.

Preferably, the first user network is configured to automatically start transmitting the user data only along the first path by means of the equal-cost multi-path routing function, in response to the increasing capacity of the first path.

### BRIEF DESCRIPTION OF THE FIGURES

Embodiments of the invention will be better understood by reading the following detailed description, given by way of example and not of limitation, to be read by referring to the accompanying drawings, wherein:

FIGS. 1a to 1d show various steps of the method according to a first embodiment of the present invention, applied to an exemplary communication system;

FIGS. 2a to 2d show various steps of the method according to a second embodiment of the present invention, applied to an exemplary communication system, in a first failure scenario; and

FIGS. 3a to 3d show various steps of the method according to the second embodiment of the present invention, applied to an exemplary communication system, in a second failure scenario.

### DESCRIPTION OF EMBODIMENTS

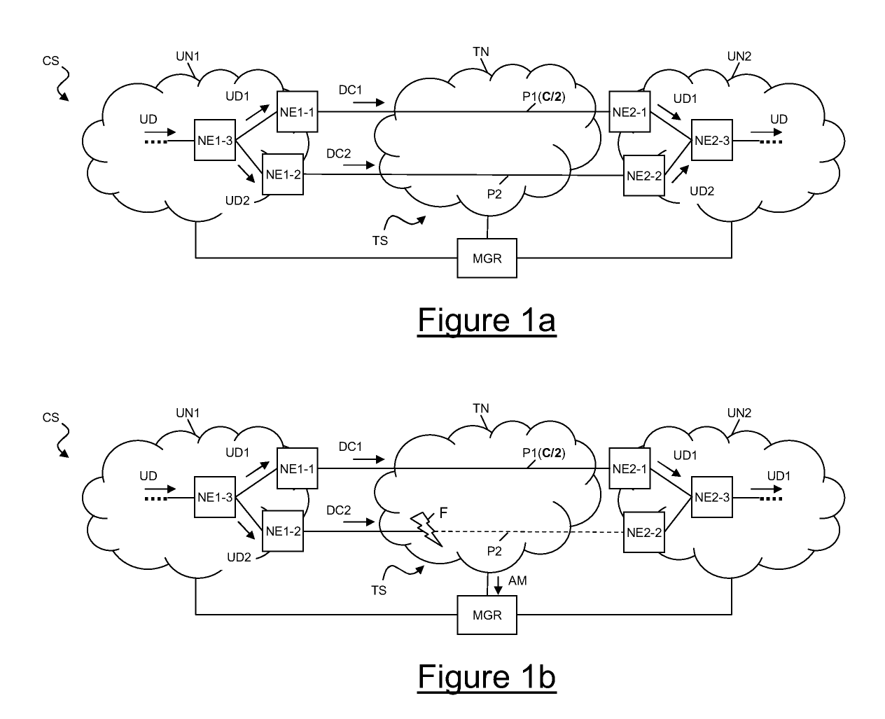

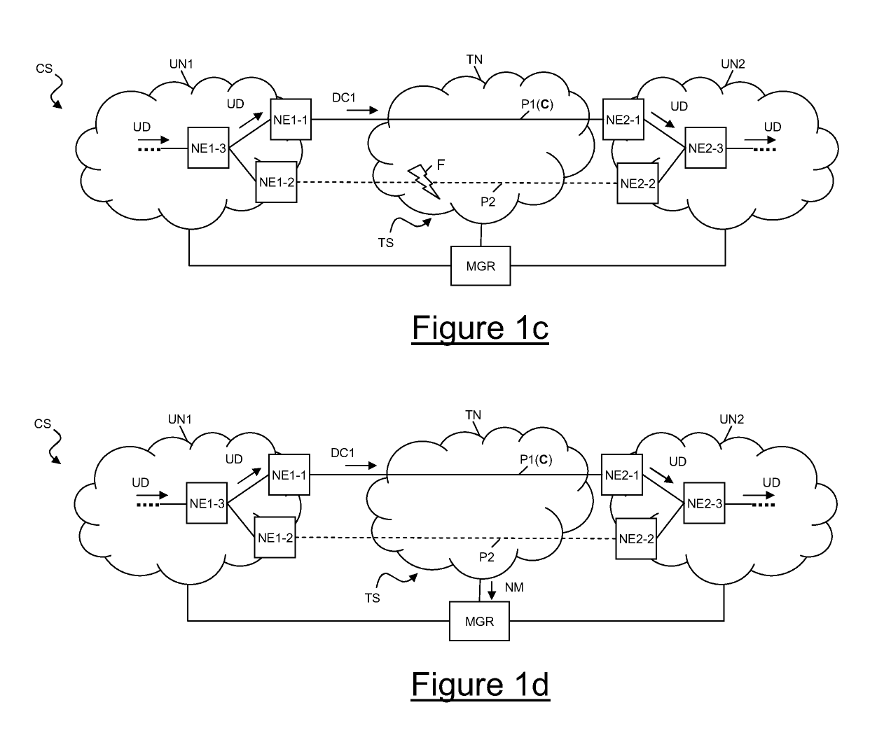

FIGS. 1a to 1d show a communication system CS in which the method for protecting transmission of user data according to a first embodiment of the present invention may be implemented.

The communication system CS comprises a transport system TS, a first user network UN1 and a second user network UN2. The transport system TS comprises a transport network TN and a network management server MGR cooperating with the transport network TN. The first user network UN1 is connected to the second user network UN2 by means of the transport network TN.

The transport network TN is preferably a circuit-switched network, such as for instance an SDH network, a SONET network, an OTN network, etc. The first user network UN1 and the second user network UN2 are preferably packet-switched networks of a same type, such as for instance Ethernet, IP, ATM, etc.

The first user network UN1 preferably comprises a number of network elements. For simplicity, in FIGS. 1a to 1d only three network elements are depicted, i.e. the network elements NE1-1, NE1-2 and NE1-3. Preferably, the network element NE1-3 is connected to both network elements NE1-1 and NE1-2. The network elements NE1-1 and NE1-2 are connected to the transport network TN by means of respective UNIs, that are not shown in the Figures for simplicity. The network elements NE1-1 and NE1-2 are then edge network elements of the first user network UN1.

Similarly, the second user network UN2 preferably comprises a number of network elements. For simplicity, in FIGS. 1a to 1d only three network elements are depicted, i.e. the network elements NE2-1, NE2-2 and NE2-3. Preferably, the network element NE2-3 is connected to both network elements NE2-1 and NE2-2. The network elements NE2-1 and NE2-2 are connected to the transport network TN by means of UNIs, that are not shown in the Figures for simplicity. The network elements NE2-1 and NE2-2 are then edge network elements of the second user network UN2.

The transport network TN preferably comprises a number of network elements and links between network elements. However, the detailed structure of the transport network TN is not shown in the Figures. In case the transport network TN is an SDH/SONET network or a OTN network, the edge network elements (not shown in the drawings) of the transport network TN are preferably configured to implement the above mentioned VCAT technique with the above mentioned LCAS mechanism.

Herein after, the method for protecting transmission of user data applied to the communication system CS according to a first embodiment of the present invention will be described in detail. To this purpose, it is assumed that user data UD having a maximum transmission rate C are generated within the first user network UN1 and has to be transmitted in a protected way to the second user network UN2 through the transport network TN.

According to this first embodiment, in a failure-free status, a first path P1 and a second path P2 are allocated in the transport network TN for transporting the user data UD. The first path P1 and the second path P2 may be calculated by the network management server MGR. Alternatively, if the transport network is an ASTN network, the first path P1 and the second path P2 may be calculated by suitable GMPLS (“Generalized Multi-Protocol Label Switching”) mechanisms implemented at all the network elements of the transport network TN.

The first path P1 connects the edge network element NE1-1 of the first user network UN1 and the edge network element NE2-1 of the second user network UN2, while the second path P2 connects the edge network element NE1-2 of the first user network UN1 and the edge network element NE2-2 of the second user network UN2. The first path P1 and the second path P2 comprise network elements and links of the transport network TN. However, for clarity of the drawings, the detailed structure of the first path P1 and the second path P2 is not shown.

Preferably, on the first path P1 a number of data containers DC1 is allocated, having an overall capacity C/2 equal to half the maximum transmission rate C of the user data UD. Similarly, on the second path P2 a number of data containers DC2 is allocated, having an overall capacity C/2 equal to half the maximum transmission rate C of the user data UD. In case the transport network TN is an SDH/SONET network (the data containers being higher order or lower order virtual containers, as mentioned above) or a OTN network (the data containers being OPUs and ODUs), on each path the data containers are preferably allocated by using the above mentioned VCAT technique. In other words, the data containers allocated on the first path P1 are part of a same virtual concatenation group, and the data containers allocated on the second path P2 are part of a same virtual concatenation group.

For instance, in case the transport network TN is an SDH/SONET network and the maximum transmission rate C is 8.96 Gbit/s, both on the first path P1 and on the second path P2, 32 higher order virtual containers VC-4 may be allocated, providing on each path P1, P2 a capacity C/2 of 4.48 Gbit/s.

After the first path P1 and the second path P2 have been allocated, in the failure-free status the user data UD are transmitted from the first user network UN1 to the second user network UN2 by using the first path P1 and the second path P2. More specifically, by referring to FIG. 1a, the user data UD are collected within the first user network UN1 by the network element NE1-3. The network element NE1-3 preferably implements the above mentioned ECMP mechanism, thus dividing the user data UD into a first data portion UD1 and a second data portion UD2. Both the first data portion UD1 and the second data portion UD2 preferably have a maximum transmission rate equal to C/2 (i.e. half the maximum transmission rate C of the user data UD). Then, the network element NE1-3 transmits the first data portion UD1 to the edge network element NE1-1, and the second data portion UD2 to the edge network element NE1-2, as shown in FIG. 1a.

The edge network element NE1-1 forwards the first data portion UD1 to its UNI (not shown in FIG. 1a), that encapsulates it and maps it into the data containers DC1 allocated on the first path P1. It has to be noticed that the allocated data containers DC1 may be only partially filled with the data of the first data portion UD1. Indeed, when the actual transmission rate of the user data UD is lower than the maximum transmission rate C, also the actual transmission rate of the first data portion UD1 is presumably lower than the capacity C/2 of the first path P1.

After mapping the first data portion UD1 into the allocated data containers DC1, the edge network element NE1-1 transmits the data containers DC1 through the transport network TN along the first path P1 towards the second user network UN2, in particular to its edge network element N2-1, as shown in FIG. 1a.

When the edge network element NE1-2 receives the second data portion UD2 from the network element NE1-3, it preferably forwards the second data portion UD2 to its UNI (not shown in FIG. 1a), that encapsulates it and maps it into the data containers DC2 allocated on the second path P2.

After mapping the second data portion UD2 into the allocated data containers DC2, the edge network element NE1-2 transmits the data containers DC2 through the transport network TN along the second path P2 towards the second user network UN2, in particular to its edge network element N2-2, as shown in FIG. 1a.

At the second user network UN2, the edge network element NE2-1 receives the data containers DC1 from the first path P1 by means of its UNI (not shown in FIG. 1a), extracts the first data portion UD1 therefrom, and forwards the first data portion UD1 to the network element NE2-3. Similarly, the edge network element NE2-2 receives the data containers DC2 from the second path P2 by means of its UNI (not shown in FIG. 1a), extracts the second data portion UD2 therefrom, and forwards the second data portion UD2 to the network element NE2-3. The network element NE2-3 then merges the first data portion UD1 and the second data portion UD2, thereby recovering the user data UD. The network element NE2-3 then forwards the user data UD to other network elements (not shown in the drawings) of the second user network UN2, according to their destinations.

It is now assumed that a failure occurs in the communication system CS. For instance, such a failure may affect one of the first path P1 and the second path P2, or one of the edge network elements NE1-1, NE1-2 of the first user network UN1, or one of the edge network elements NE2-1, NE2-2 of the second user network UN2, or one of the links connecting the network element NE1-3 to the edge network elements NE1-1, NE1-2 of the first user network UN1, or one of the links connecting the network element NE2-3 to the edge network elements NE2-1, NE2-2 of the second user network UN2.

Herein after, by way of example, it is assumed that a failure F occurs on the second path P2. For instance, one of the links of the transport network TN forming the second path P2 becomes failed. This exemplary situation is shown in FIG. 1b. Due to the failure F, transmission of the data containers DC2 along the second path P2 is interrupted upstream the failure F.

When the failure F is detected within the transport network TN (typically, by a network element downstream the failure F along the second path P2), the transport network TN preferably notifies the failure to the network management server MGR. To this purpose, the network element detecting the failure F preferably transmits an alarm message AM to the network management server MGR, as shown in FIG. 1b. The alarm message AM is preferably formatted according to a management protocol, such as for instance SNMP (Simple Network Management Protocol)/QB3.

Upon reception of the alarm message AM from the transport network TN, the network management server MGR preferably switches from the failure-free status to a failure status by operating the transport network TN so as to increase the capacity of the first path P1 from its current capacity C/2 to the maximum transmission rate C of the user data UD, namely by doubling the number of data containers DC1 allocated on the first path P1. Preferably, if the transport network TN is an SDH/SONET network or an OTN network, and the data containers DC1 on the first path P1 have been allocated by means of the above mentioned VCAT technique (also implementing the LCAS mechanism), the network management server MGR preferably induces the transport network TN to double the number of data containers DC1 allocated on the first path P1 by suitably operating the LCAS mechanism executed by the edge network elements of the transport network TN. Therefore, for instance, if the maximum transmission rate C is 8.96 Gbit/s and 32 higher order virtual containers VC-4 are allocated both on the first path P1 and on the second path P2 (providing on each path a capacity C/2 of 4.48 Gbit/s), the network management server MGR operates the LCAS mechanism for raising the number of higher order virtual containers VC-4 allocated on the first path P1 from 32 to 64. This allows providing the first path P1 with a doubled capacity C, i.e. 8.96 Gbit/s.

Then, after the capacity of the first path P1 has been increased, in the failure status the ECMP mechanism implemented at the network element NE1-3 of the first user network UN1 induces the network element NE1-3 to forward all the user traffic UD collected from the other network elements of the first user network UN1 to the edge network element NE1-1, i.e. the edge network element connected to the path not affected by the failure F.

Therefore, advantageously, after intervention of the network management server MGR, in the failure status the user data UD collected at the network element NE1-3 of the first user network UN1 are all forwarded to the network element NE1-1, that transmits it along the first path P1, as show in FIG. 1c. The first path P1 is now capable of supporting transmission of the whole user data UD, even when the actual transmission rate of the user data UD is equal to the maximum transmission rate C. Therefore, while the failure F on the second path P2 is being fixed, transmission of the user data UD is protected by the first path P1, having now doubled capacity.

Therefore, advantageously, according to this first embodiment of the invention, resources of the transport network TN are used in a more efficient way than according to prior art solutions for protecting transmission of user data. Indeed, while according to the prior art solution the additional resources for protecting transmission of user data on both paths are allocated a priori in the transport network, and are accordingly unused until a failure occurs, according to this first embodiment the additional resources for protecting transmission of user data are allocated only upon detection of a failure, on the path that is not affected by the failure. Indeed, while the communication system is normally operating (i.e. in the failure-free status), in the transport network an amount of resources is reserved for transmission of user data on the two paths, that is tailored for allowing transmission of user data at their maximum transmission rate, i.e. C. When a failure occurs on one of the two paths, additional resources are allocated on the path not affected by the failure, in response to detection of the failure. Then, if no failures occur, no unused additional resources are needed.

When the failure F is fixed, the initial configuration of the communication system is preferably restored. More specifically, when the failure F is fixed, the network management server MGR receives a notification message NM from the transport network TN, as shown in FIG. 1d. The notification message MM is preferably formatted according to a management protocol, such as for instance the above cited SNMP/QB3.

Upon reception of such a notification message NM, the network management server MGR preferably switches from the failure status to the failure-free status by operating the transport network TN so as to decrease the capacity of the first path P1 from its current capacity C (equal to the maximum transmission rate C of the user data UD) to its initial value C/2, by halving the number of data containers DC1 allocated on the first path P1. Preferably, in case the transport network TN is an SDH/SONET network or an OTN network, and the data containers DC1 on the first path P1 have been allocated by means of the above mentioned VCAT technique also implementing the LCAS mechanism, the network management server MGR preferably induces the transport network TN to halve the number of data containers DC1 allocated on the first path P1 by suitably operating the LCAS mechanism executed at the edge network elements of the transport network TN. Therefore, for instance, if the maximum transmission rate C is 8.96 Gbit/s and 64 higher order virtual containers VC-4 are allocated on the first path P1 (providing a capacity C of 8.96 Gbit/s) when the second path P2 is failed, the network management server MGR operates the LCAS mechanism for reducing the number of higher order virtual containers VC-4 allocated on the first path P1 from 64 to 32. This allows providing the first path P1 with its initial capacity C/2, i.e. 4.48 Gbit/s.

Then, preferably, after the capacity on the first path P1 has been decreased, the ECMP mechanism implemented at the network element NE1-3 of the first user network UN1 induces the network element NE1-3 to divide again the user traffic UD collected from the other network elements of the first user network UN1 in a first data portion UD1 to be forwarded to the edge network element NE1-1 and a second data portion UN2 to be forwarded to the edge network element NE1-2. After intervention of the network management server MGR, the operation of the communication system CS is therefore the same as before the failure F occurred (see FIG. 1a).

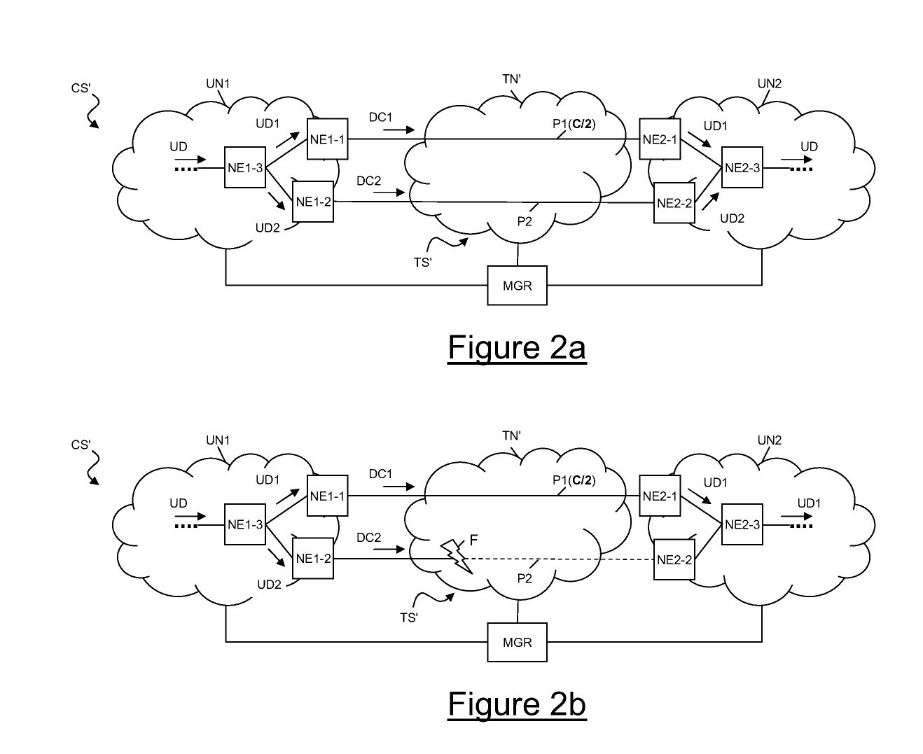

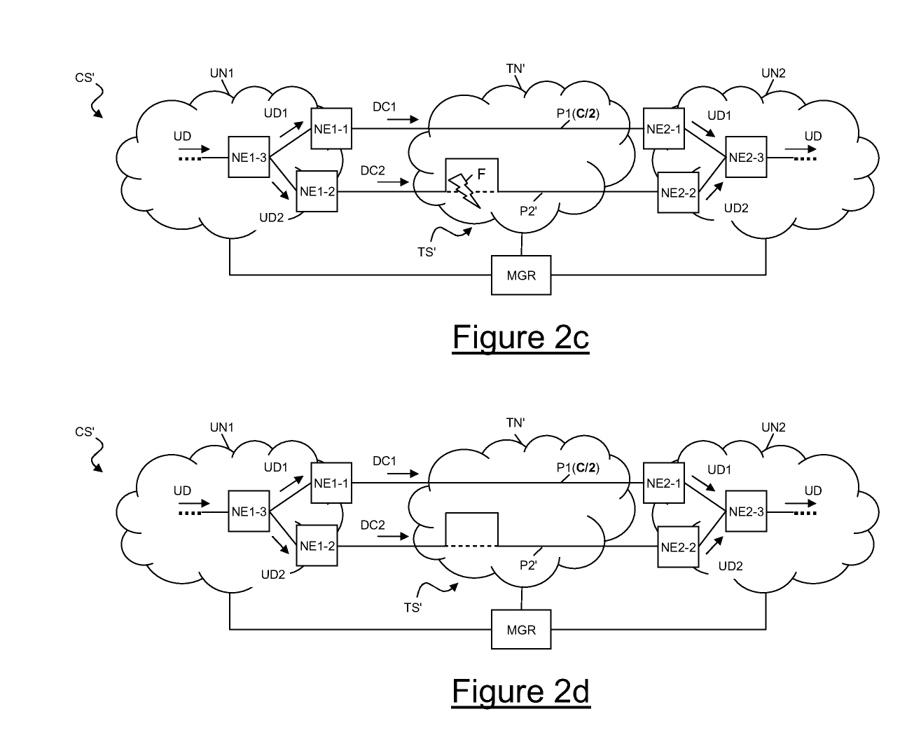

FIGS. 2a to 2d show a communication system CS′ in which the method for protecting transmission of user data according to a second embodiment of the invention may be implemented.

The structure of the communication system CS′ is substantially similar to the structure of the communication system CS shown in FIGS. 1a to 1d. A detailed description will therefore not be repeated. The only difference is that the transport network TN′ is a circuit-switched network of the above mentioned ASTN type, i.e. it is provided with GMPLS (“Generalized Multi-Protocol Label Switching”) mechanisms allowing the transport network TN′ to autonomously modify the paths when a change occurs in the network.

When the communication system CS′ normally operates in the failure-free status (see FIG. 2a), its operation is similar to the operation of the communication system CS′ as described above with reference to FIG. 1a. A detailed description will therefore not be repeated.

When a failure F occurs in the transport network TN′, for example on the second path P2 transporting the second data portion UD2 of the user data UD (as shown in FIG. 2b), according to this second embodiment the transport network TN′ preferably modifies the second path P2, without requiring any intervention of the network management server MGR, by using the GMPLS mechanisms. For instance, as shown in FIG. 2c, the transport network TN′ may allocated a portion of path bypassing the failure F, i.e. branching off the second path P2 at a network element located upstream the failure F, and joining again the second path P2 at a network element located downstream the failure F, so as to form a modified second path P2′. The GMPLS mechanisms also preferably changes configuration of the network elements at which the portion of path bypassing the failure F branches off and joins again the second path P2, so that the data containers DC2 in which the second data portion UD2 is mapped are now transmitted along the modified second path P2′.

On this portion of path bypassing the failure F, a number of data containers is allocated, so that the capacity of the portion is equal to the capacity of the second path P2, i.e. C/2. This modified second path P2 is therefore capable of continuing supporting transmission of the second data portion UD2.

When the failure F is fixed (FIG. 2d), the second data portion UD2 may continue being transmitted along the modified second path P2′. Alternatively, after the failure F is fixed the GMPLS mechanisms of the transport network TN′ may automatically change again configuration of the network elements at which the portion of path bypassing the fixed failure F branches off and joins again the second path P2, for reverting transmission of the data containers DC2 to the originally allocated path P2.

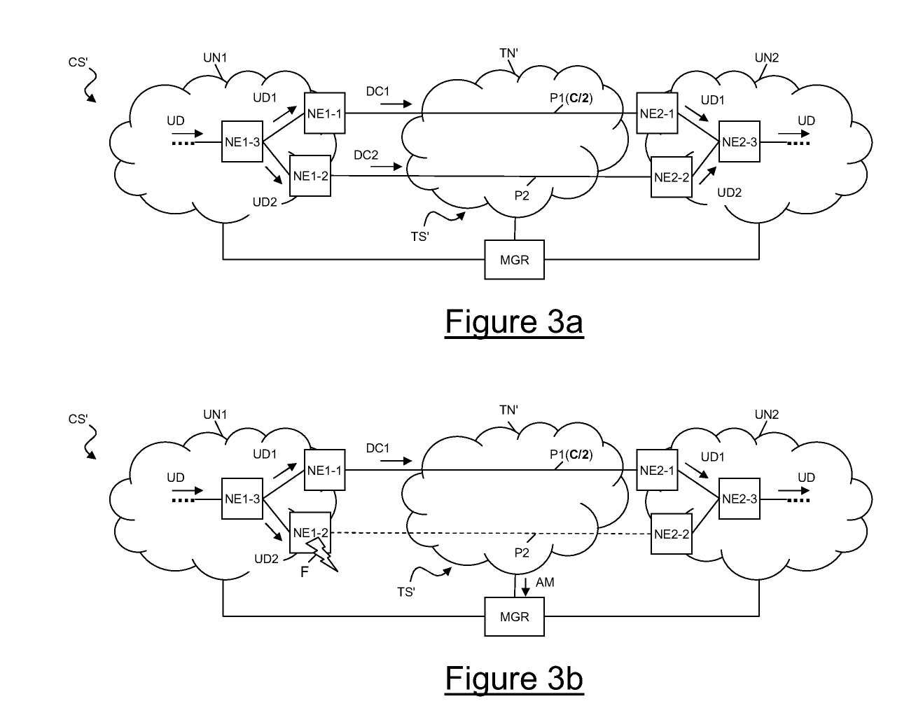

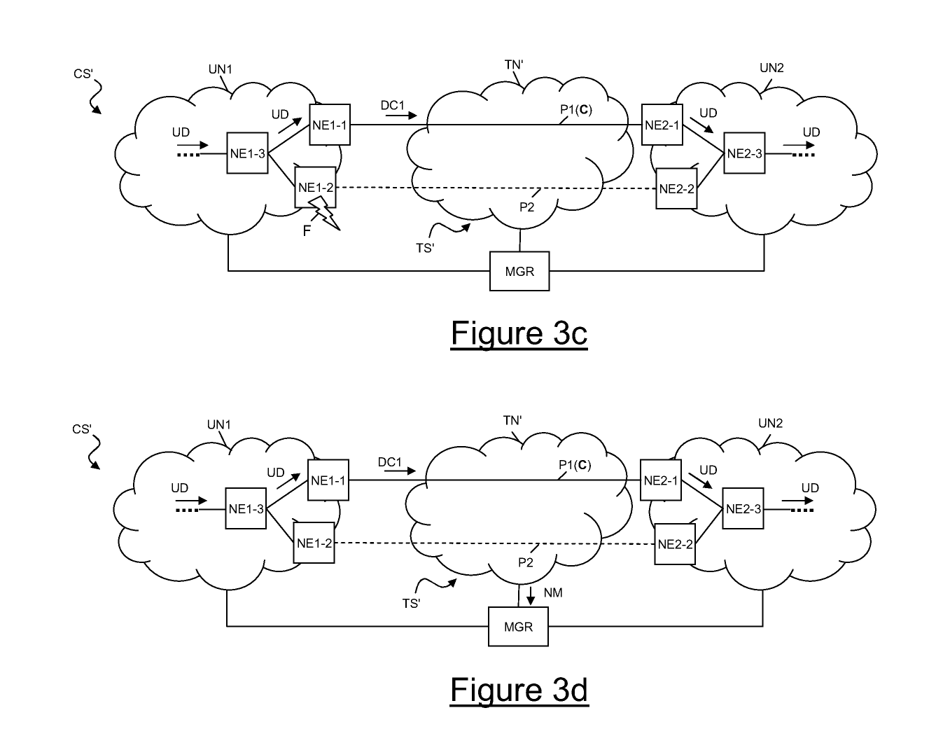

With reference to FIGS. 3a to 3d, it is now assumed that the failure F occurs out of the transport network TN′, e.g. at one of the edge network elements of the first user network UN1, e.g. the edge network element NE1-2, as shown in FIG. 3b.

The operation of the communication system CS′ in the failure-free status (see FIG. 3a) is similar to the operation of the communication system CS described above with reference to FIG. 1a. A detailed description will therefore not be repeated.

When the failure F occurs at the edge network element NE1-2 of the first user network UN1, the GMPLS mechanisms can not protect transmission of the user data UD, since the failure F is out of the transport network TN′. According to this second embodiment, when the failure F is detected (typically, by a network element of the transport network TN′ downstream the failure F along the second path P2), the transport network TN′ preferably notifies the failure to the network management server MGR. To this purpose, the network element detecting the failure F preferably transmits an alarm message AM to the network management server MGR, as shown in FIG. 3b. Also in this second embodiment, the alarm message AM is preferably formatted according to a management protocol, such as for instance the above mentioned SNMP/QB3.

Upon reception of the alarm message AM from the transport network TN′, the network management server MGR preferably switches from the failure-free status to a failure status by operating the transport network TN so as to increase the capacity of the first path P1 from its current capacity C/2 to the maximum transmission rate C of the user data UD, namely by doubling the number of data containers DC1 allocated on the first path P1. Preferably, also according to this second embodiment, in case the transport network TN′ is an SDH/SONET network or an OTN network, and the data containers DC1 on the first path P1 have been allocated by means of the above mentioned VCAT technique (also implementing the LCAS mechanism), the network management server MGR preferably induces the transport network TN′ to double the number of data containers DC1 allocated on the first path P1 by suitably operating the LCAS mechanism executed by the edge network elements of the transport network TN′.

Then, after the capacity of the first path P1 has been increased, in the failure status the ECMP mechanism implemented at the network element NE1-3 of the first user network UN1 induces the network element NE1-3 to forward all the user traffic UD collected from the other network elements of the first user network UN1 to the edge network element NE1-1, i.e. the edge network element connected to the path not affected by the failure F.

Therefore, advantageously, after intervention of the network management server MGR, also according to this second embodiment, in the failure status the user data UD collected at the network element NE1-3 of the first user network UN1 are all forwarded to the network element NE1-1, that transmits it along the first path P1, as show in FIG. 3c. The first path P1 is now capable of supporting transmission of the whole user data UD, even when the actual transmission rate of the user data UD is equal to the maximum transmission rate C. Therefore, also according to this second embodiment, while the failure F on the second path P2 is being fixed, transmission of the user data UD is protected by the first path P1, having now doubled capacity.

When the failure F is fixed, the initial configuration of the communication system CS′ is preferably restored. More specifically, when the failure F is fixed, the network management server MGR receives a notification message NM from the transport network TN′, as shown in FIG. 3d. Preferably, the notification message NM is formatted according to a management protocol, such as for instance the above cited SNMP/QB3.

Upon reception of such a notification message NM, the network management server MGR preferably switches from the failure status to the failure-free status by operating the transport network TN so as to decrease the capacity of the first path P1 from its current capacity C (equal to the maximum transmission rate C of the user data UD) to its initial value C/2, by halving the number of data containers DC1 allocated on the first path P1. Preferably, in case the transport network TN′ is an SDH/SONET network or an OTN network, and the data containers DC1 on the first path P1 have been allocated by means of the above mentioned VCAT technique also implementing the LCAS mechanism, the network management server MGR preferably operates the transport network TN′ so as to halve the number of data containers DC1 allocated on the first path P1, by suitably operating the LCAS mechanism executed at the edge network elements of the transport network TN′.

Then, preferably, after the capacity on the first path P1 has been decreased, the ECMP mechanism implemented at the network element NE1-3 of the first user network UN1 induces the network element NE1-3 to divide again the user traffic UD collected from the other network elements of the first user network UN1 in a first data portion UD1 to be forwarded to the edge network element NE1-1 and a second data portion UN2 to be forwarded to the edge network element NE1-2.

Therefore, advantageously, according to this second embodiment the mechanism for protecting transmission of user data in a transport network complements the GMPLS mechanisms of the ATSN-type transport network TN′. Indeed, when the failure F occurs within the transport network TN′, the GMPLS mechanisms take actions for protecting transmission of user traffic, without requiring any intervention of the network management server MGR. On the other hand, advantageously, when a failure occurs outside the transport network TN′, the network management server MGR suitably operates the transport network TN′ for increasing capacity of the failure-free path, thus allowing it to protect transmission of the user data.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

1. A method for protecting transmission of user data transmitted from a first user network to a second user network through a transport network, said user data having a maximum transmission rate, said method comprising the steps of:
a) in said transport network, in a failure-free status, providing a first path and a second path connecting said first user network with said second user network, said first path and said second path having an overall capacity equal to said maximum transmission rate;
b) transmitting a first portion of said user data along said first path, and transmitting a second portion of said user data along said second path;
c) at a network management server cooperating with said transport network, detecting a failure affecting transmission of said second portion;
d) at said network management server, switching from said failure-free status to a failure status by operating said transport network to increase capacity of said first path to said maximum transmission rate; and
e) at said first user network, transmitting said user data along said first path only.

2. The method according to claim 1, wherein said step a) further comprises the step of allocating a first number of data containers on said first path and a second number of data containers on said second path by means of a virtual concatenation technique implemented by said transport network.

3. The method according to claim 2, wherein said step d) further comprises the step of increasing said first number of data containers by operating a link capacity adjustment scheme implemented by said transport network.

4. The method according to claim 1, wherein said step c) further comprises the step of receiving at said network management server a management message from said transport network, said management message being indicative of said failure.

5. The method according to claim 1 wherein, after said step c), the method further comprises the step of, if said transport network is an automatic switched transport network, using automatic switching functionalities of said transport network for allocating a path portion bypassing said failure, if said failure occurs on said second path.

6. The method according to claim 1, wherein said step b) further comprises the step of implementing an equal-cost multi-path routing function in said first user network, so that said first portion is transmitted through a first edge network element of said first user network to said first path, and said second portion through a second edge network element of said first user network to said second path.

7. The method according to claim 6, wherein said first user network automatically performs said step e) in response to said step d) by means of said equal-cost multi-path routing function.

8. A transport system comprising a transport network and a network management server cooperating with said transport network, said transport network being suitable for connecting a first user network with a second user network,
wherein said transport network has a first path and a second path configured to connect said first user network with said second user network, and
wherein, in a failure-free status, said first path is suitable for supporting transmission of a first portion of user data and said second path is suitable for supporting transmission of a second portion of said user data, said first path and said second path having an overall capacity equal to a maximum transmission rate of said user data, and
wherein said network management server is configured to detect a failure affecting transmission of said second portion and, in response to said detection, to switch from said failure-free status to a failure status by operating said transport network to increase capacity of said first path to said maximum transmission rate, thereby allowing said first path supporting transmission of all said user data.

9. The transport system according to claim 8, wherein said transport network is configured to implement a virtual concatenation technique and to use said virtual concatenation technique for allocating a first number of data containers on said first path and a second number of data containers on said second path.

10. The transport system according to claim 9, wherein said transport network is configured to implement a link capacity adjustment scheme, and wherein said network management server is configured to operate said link capacity adjustment scheme for increasing capacity of said first path by increasing said first number of data containers.

11. The transport system according to claim 8, wherein said network management server is configured to detect said failure by receiving from said transport network a management message indicative of said failure.

12. The transport system according to claim 8, wherein said transport network is an automatic switched transport network configured to use automatic switching functionalities for allocating a path portion bypassing said failure, if said failure occurs on said second path.

13. A communication system comprising a first user network, a second user network and a transport system, the transport system comprising a transport network and a network management server cooperating with said transport network, said transport network connecting said first user network with second user network.

14. The communication system according to claim 13, wherein said first user network is configured to implement an equal-cost multi-path routing function, so that said first portion is transmitted through a first edge network element of said first user network to said first path, and said second portion is transmitted through a second edge network element of said first user network to said second path.

15. The communication system according to claim 14, wherein said first user network is configured to automatically start transmitting said user data only along said first path by means of said equal-cost multi-path routing function, in response to said increasing capacity of said first path.
